(19) United States
(12) Patent Application Publication
(10) Pub. No.: US 2012/0326678 A1
(43) Pub. Date: Dec. 27, 2012

(54) Method for Protecting an Automotive Generator From Overheating

(76) Inventors: Arnold Engber, Hoesbach (DE); Helmut Suelzle, Freiberg (DE); Miriam Riederer, Fellbach (DE)

(21) Appl. No.: 13/498,662

(22) PCT Filed: Aug. 26, 2010
(86) PCT No.: PCT/EP2010/062427

§ 371 Date: Jun. 15, 2012

(30) Foreign Application Priority Data
Sep. 30, 2009 (DE) 10 2009 045 147.1

(51) Int. Cl. H02P 9/02

(52) U.S. Cl. 322/34

(57) ABSTRACT

A method for protecting an automotive generator from overheating, in which a predefined limiting characteristic curve, related to a base temperature and describing a maximally allowed excitation current value, is shifted as a function of a calculated temperature, a static offset is ascertained in a first step and a dynamic offset is ascertained in a second step during ascertainment of the calculated temperature, the static offset is ascertained as a function of the excitation current and the dynamic offset is ascertained as a derivation of the excitation current over time.

### FIELD OF THE INVENTION

The present invention relates to a method for protecting an automotive generator from overheating.

### BACKGROUND INFORMATION

German patent document DE 41 02 335 A1 discusses a method and a device for regulating a generator having an excitation winding and a voltage regulator. The voltage regulator regulates the output voltage of the generator by influencing the excitation current. Furthermore, a temperature detection device is also provided. The generator is designed in such a way that an allowed limiting temperature could occur on the generator or the device itself with a heavy load and/or high external temperatures, in particular at a low generator speed. Furthermore, an arrangement for influencing the excitation current is provided which reduce the excitation current before or on reaching a limiting temperature at a predefinable point. The voltage regulator may be designed as a microcomputer, in which the required calculations as well as setpoint/actual value comparisons are performed, taking into account measured variables such as the regulator temperature and taking into account characteristic values stored in the microcomputer.

The characteristic values include the stored characteristic values of the generator, of the voltage regulator, and of the vehicle, as well as installation-specific characteristic values. In addition, limiting temperatures up to which heating is allowed are stored. These limiting temperatures may be defined uniformly for the system as a whole, or it may be established that different points may be heated up to different limiting temperatures. In the microcomputer, calculations are performed continuously based on the prevailing regulator temperature, the stored characteristic values and, if necessary, additional measured variables, for example, the generator speed, to calculate how high the prevailing temperature is at predefinable points of the generator/voltage regulator system. If such a calculated temperature exceeds one or more predefined limiting temperatures, the excitation current is reduced by triggering a switch transistor, so that the temperature does not exceed the selected limiting value(s). However, the method described above operates inaccurately because the time constant of the regulator temperature differs from the time constants of the component temperatures.

German patent document DE 41 41 837 B4 discusses a device for regulating a generator having an excitation winding and a voltage regulator. The voltage regulator regulates the output voltage of the generator by influencing the excitation current. The voltage regulator has an arrangement for detecting the temperature of the voltage regulator. The voltage regulator or an additional arrangement for influencing the excitation current may reduce the excitation current on reaching at least one limiting temperature or one limiting temperature range. A microprocessor determines from stored characteristic values and at least one detected variable a final temperature, which arises in steady-state operation, of at least one predefinable component of the device with the aid of an observer function. As a function of this final temperature, the microprocessor ascertains the temperature characteristic and/or the prevailing temperature of the respective component and compares it with the limiting temperature. The arrangement for influencing the excitation current utilize characteristic values of the generator, characteristic values of the voltage regulator, characteristic values of the vehicle, and/or installation-specific stored characteristic values for calculating the temperature at predefinable points of the device. Continuously ascertained signals, the temperature of the voltage regulator and the rotational speed of the generator, may also be taken into account in the voltage regulator in calculating the temperature at predefinable points. The temperature at another selectable point of the system is then calculated from this in the microprocessor. The temperature characteristic over time is formed by evaluating a change in resistance or by evaluating the temperature of a temperature-dependent resistance as a function of the ascertained steady-state final temperature value. As an alternative, the temperature characteristic over time may also be formed by evaluating the heating of a semiconductor segment, in particular the heating of a Zener diode, as a function of the ascertained steady-state final temperature value.

German patent document DE 10 2006 019 625 A1 discusses a temperature detector device for an electric generator for detecting a temperature of an electric generator. This device has a temperature detector of a control device, which is configured for detecting a temperature of the control device, which is electrically connected to the electric generator containing an excitation winding. The control unit controls the supply of an excitation current to the excitation winding. In addition, it outputs a control unit temperature signal, which represents the detected temperature of the control unit. Furthermore, the device has a rotational speed detector, which outputs a rotational speed signal representing the rotational speed of the electric generator. In addition, an excitation current detector is provided, which outputs an excitation current signal representing the excitation current. Finally, a temperature-determining device is provided for the electric generator which determines a temperature of the electric generator. This takes place based on the control unit temperature signal from the temperature detector of the control unit, the rotational speed signal, the excitation current signal and an output voltage of the electric generator. An electric generator temperature signal, representing the specific temperature of the electric generator, is output at the output of the temperature-determining device. A static temperature of the electric generator in a static state and a transitional temperature of the electric generator at a point in time during a transitional state are ascertained with the aid of the temperature-determining device based on the static temperature and a predetermined operating parameter, which is assigned to a rate of change in temperature of the electric generator during the transitional state. The electric generator includes, among other things, a rectifier, which is configured in such a way that the temperature of the electric generator, which is determined with the aid of the temperature-determining device of the electric generator, is the temperature of the rectifier.

### SUMMARY OF THE INVENTION

A method having the features described herein has the advantage over the related art that components of the automotive generator having greater thermal time constants than the regulator of the generator as well as components of the automotive generator having smaller thermal time constants than the regulator of the generator may be effectively protected from overheating. This advantage is based essentially on the fact that the dynamic offset, which is used in ascertaining the temperature value, is ascertained as a derivation of the excitation current over time. This also permits effective protection from overheating of components of the automotive generator whose thermal time constant is smaller than the thermal time constant of the regulator of the generator.

The derivation of the excitation current is advantageously weighted. This has the advantage that a relatively minor change in the excitation current may be converted into a greater change in the regulator temperature due to the weighting.

The derivation of the excitation current may also be subjected to a delay. This has the advantage that a relatively rapid change in the excitation current may be converted into a more gradual change in regulator temperature due to the delay.

Additional advantageous properties of the exemplary embodiments and/or exemplary method of the present invention are derived from the following explanation with reference to the drawings.

### BRIEF DESCRIPTION OF THE DRAWINGS

FIG. 1 shows a flow chart to illustrate a method for protecting an automotive generator from overheating.

FIG. 2 shows a diagram to illustrate an example of a temperature-dependent characteristic curve shift.

FIG. 3 shows a diagram to illustrate an example of how a temperature value is ascertained.

FIG. 4 shows a block diagram of a device for ascertaining a temperature value.

FIG. 5 shows diagrams to illustrate one exemplary embodiment for ascertaining a dynamic offset in the case of a load application.

FIG. 6 shows diagrams to illustrate one exemplary embodiment of ascertaining a dynamic offset in the case of a load interruption.

### DETAILED DESCRIPTION

FIG. 1 shows a flow chart illustrating a method for protecting an automotive generator from overheating. According to a step S1 in this method, a limiting characteristic curve related to a base temperature is indicated. This limiting characteristic curve is established in advance at the factory for the type of automotive generator based on measurements, saved in a nonvolatile form, and then stored in a nonvolatile memory of the generator regulator, for example, as part of the production of the respective automotive generator. The base temperature is, for example, a high temperature of 120° C. at which a limitation would usually occur. The limiting characteristic curve contains information about which excitation current is maximally allowed at which rotational speed of the automotive generator. The limiting characteristic curve related to the base temperature is ascertained as a function of the rotational speed and the temperature of the automotive generator. Alternatively, the limiting characteristic curve related to the base temperature may also be ascertained as a function of the rotational speed, the temperature and the output voltage of the automotive generator.

A static offset SO is ascertained in a subsequent step S2. This static offset is ascertained either as a function of excitation current IE or as a function of excitation current IE and rotational speed n of the automotive generator. This static offset corresponds to the temperature difference between the measured temperature of the generator regulator and the calculated temperature in the thermally steady-state condition and is calculated as a factored excitation current: SO=K1·IE, where SO is the static offset, K1 is a factor, and IE is the excitation current.

Next, in a step S3, a dynamic offset DO is ascertained. This dynamic offset is ascertained as the derivation of the excitation current over time. It corresponds to a correction of the static offset for the period of time in which the temperature of the generator regulator has not yet reached its thermally steady-state value. It is ascertained according to the following equation:

DO(k)=K2·IE(k)−K3·IE(k−1)+K4·DO(k−1),

where DO is the dynamic offset at a predefined point in time, IE(k) is the excitation current at the predefined point in time, IE(k−1) is the excitation current at a predefined previous point in time, and DO(k−1) is the dynamic offset at the predefined previous point in time. K2, K3 and K4 are factors. Factors K2 and K3 may assume the same values.

A calculated temperature is calculated in a subsequent step S4. This calculated temperature is provided to shift the limiting characteristic curve, which is predefined in step S1 and describes the maximally allowed excitation currents, as a function of the calculated temperature. The calculated temperature is calculated according to the following equation: TV=TR−SO+DO, where TV is the calculated temperature, TR is the measured temperature of the generator regulator, SO is the static offset and DO is the dynamic offset.

In a step S5, the limiting characteristic curve is shifted as a function of the calculated temperature. This shift in the limiting characteristic curve achieves the result that in the case when a high calculated temperature is present, the limiting characteristic curve is shifted in the direction of lower excitation currents, and in the case when a low calculated temperature is present, the limiting characteristic curve is shifted in the direction of higher excitation currents. As a result, the automotive generator always operates at an optimized power. It is ensured that components of the automotive generator whose thermal time constants are greater than the thermal time constant of the generator regulator as well as components of the automotive generator whose thermal time constants are less than the thermal time constant of the generator regulator are effectively protected from overheating. It is also ensured that the output voltage of the automotive generator is not reduced to an unnecessary extent.

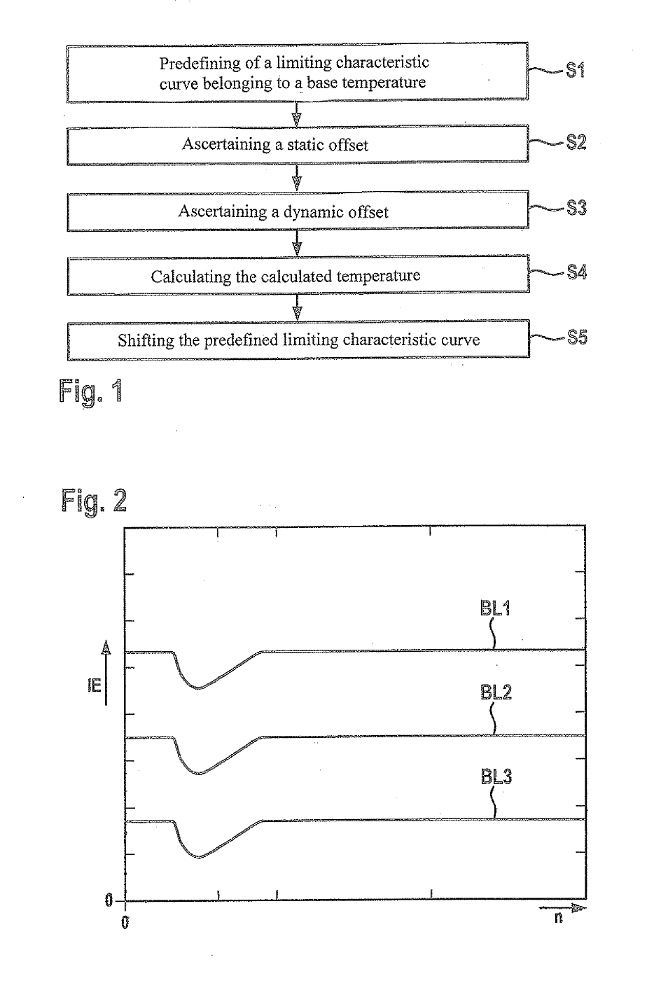

FIG. 2 shows a diagram illustrating an example of a temperature-dependent characteristic curve shift. FIG. 2 shows rotational speed n of the automotive generator plotted on the abscissa and excitation current IE plotted on the ordinate. Limiting characteristic curve BL1 is related to a calculated temperature T1, limiting characteristic curve BL2 is related to a calculated temperature T2, and limiting characteristic curve BL3 is related to a calculated temperature T3. It holds that:

T3>T2>T1.

It is apparent here that at a low calculated temperature T1, excitation current IE may be selected to be the greatest, that at an average calculated temperature T2, the excitation current may be selected to be in the medium range, and that at a high calculated temperature, the excitation current must have a low value, i.e., it must be limited the most.

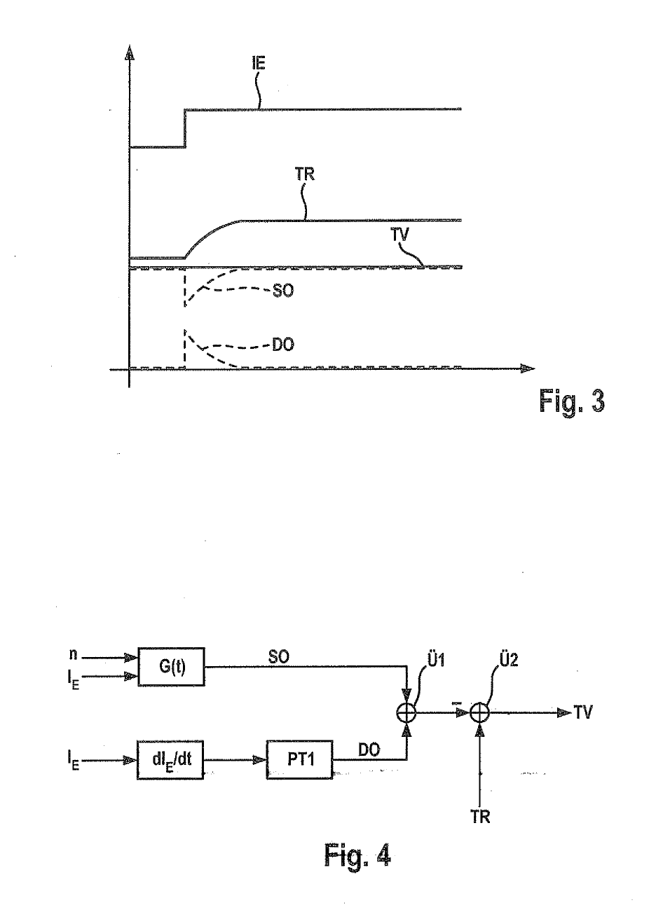

FIG. 3 shows a diagram illustrating an example of ascertaining the calculated temperature. This figure shows examples of curves of excitation current IE, temperature TR of the generator regulator, static offset SO, dynamic offset DO, and ascertained calculated temperature TV.

It is apparent here that when excitation current IE increases, temperature TR of the generator regulator rises slowly up to an elevated level and then remains at this level. Static offset SO is subtracted from the temperature of the generator regulator and the dynamic offset is added. The result is that calculated temperature TV is ascertained.

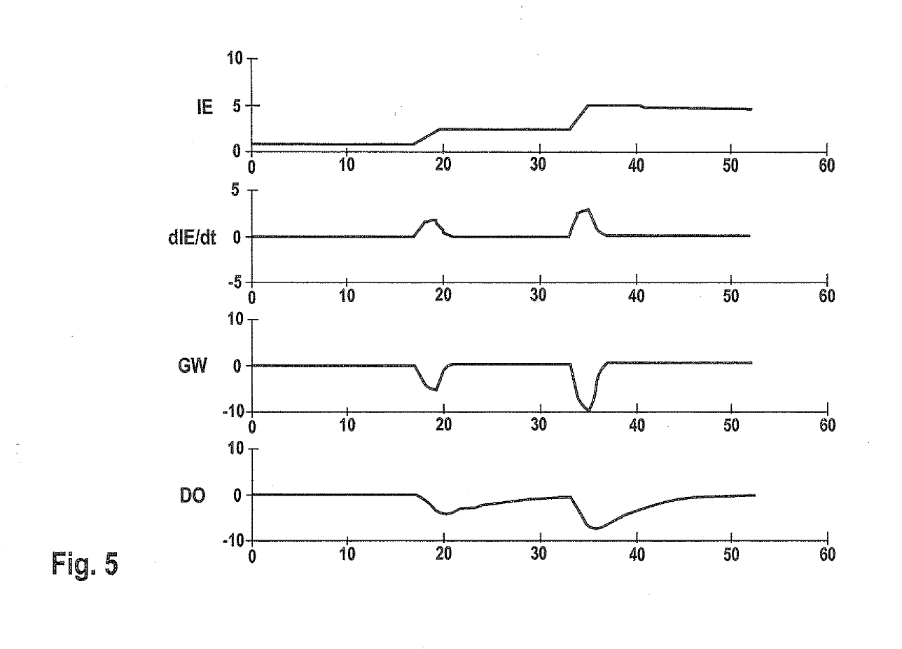

FIG. 4 shows a block diagram of a device for ascertaining the calculated temperature using rotational speed n of the automotive generator and excitation current IE as input variables. In the upper branch, static offset SO is ascertained from rotational speed n and excitation current IE in a processing unit G(t). In the lower branch, the excitation current is derived according to time dIE/dt, which is then sent over a PT1 segment to ascertain dynamic offset DO. Static offset SO and dynamic offset DO are set off against each other in a first heterodyner Ü1. The output signal of first heterodyner Ü1 is subtracted from measured regulator temperature TR in a second heterodyner Ü2, so that the calculated temperature is available at the output of second heterodyner Ü2.

FIG. 5 shows diagrams to illustrate one exemplary embodiment of ascertaining a dynamic offset in the case of a load application. Excitation current IE is shown in the top diagram, the derivation of the excitation current according to time dIE/dt is shown in the second diagram, a weighted derivation GW is shown in the third diagram, and dynamic offset DO is shown in the fourth diagram.

In the case of such a load application, the regulator temperature is initially lower than in the thermally steady-state condition. If the calculated temperature for this operating state of the load application were calculated using only the generator regulator temperature and the static offset, then the calculated temperature ascertained would be too low. Due to this calculated temperature being too low, a too high excitation current would be allowed initially, which could then result in damage to components of the automotive generator. By including the dynamic offset, the calculated temperature is ascertained correctly and a prompt limitation of the excitation current takes place.

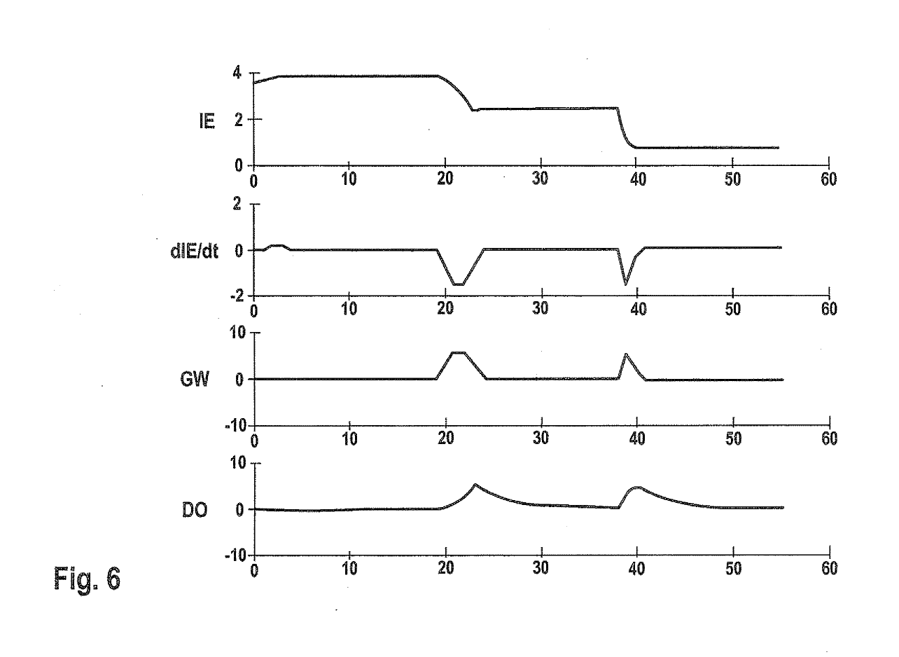

FIG. 6 shows diagrams to illustrate one exemplary embodiment for ascertaining a dynamic offset in the case of a load interruption. The top diagram again shows excitation current IE, the second diagram shows the derivation of the excitation current according to time dIE/dt, the third diagram shows a weighted derivation GW and the fourth diagram shows dynamic offset DO.

In the case of such a load interruption, the regulator temperature is initially higher than in the thermally steady-state condition because the regulator was heated in the previous load state by the resulting power loss. This heating cools down to a lower steady-state level only according to the thermal time constant of the regulator. This means that immediately after a load interruption, the calculated temperature would be calculated as being too high if only the generator regulator temperature and the steady-state offset were taken into account. This would result in an excitation current limitation being initiated for certain operating states, although such an excitation current limitation would not be necessary at all for these operating states. This would mean a loss of generator power. However, since the dynamic offset has been included, the calculated temperature is ascertained correctly and no unnecessary reduction in the excitation current takes place.

With the aid of the method described above, the calculated temperature may be ascertained precisely for stable operating states of the generator as well as during the change between two operating states. This has the advantage that a required excitation current limitation may always be initiated precisely. If limiting values are imminently to be exceeded, this is always detected so promptly that it is possible to prevent the limiting values from actually being exceeded. Moreover, losses of generator power which occur due to a reduction in the excitation current initiated too quickly may be prevented. Furthermore, an approach in the sense of the method described above is an inexpensive option in comparison with a use of temperature sensors.

An advantageous refinement of the exemplary embodiments and/or exemplary method of the present invention involves additionally taking into account the influence of neighboring generator components during ascertainment of the calculated temperature. This influence of neighboring generator components may be detected in the thermal behavior of the diodes during a cold start, for example, or during operating states resembling a cold start. Thus, the diode temperatures are also influenced by the temperature of the stator of the generator, among other things. The stator temperature rises more slowly than the diode temperature but it reaches a higher absolute value. As a result, in a diagram in which the diode temperature and the stator temperature are plotted over the time, there is a point of intersection of these characteristic curves. Beyond the point in time at which the stator temperature exceeds the diode temperature, the stator causes an additional input of heat into the diodes. This results in the diode temperature exceeding a maximally allowed temperature during a cold start, although the limit function described above limits the excitation current reliably in all thermally stable conditions.

In order to measure up to such influences of neighboring generator components, the heat input induced by neighboring generator components is compensated by taking into account an additional offset. This additional offset depends on the change in the calculated temperature. The change in the calculated temperature over time is associated with an increase in the temperature of neighboring generator components, for example, the stator temperature.

To ascertain the additional offset, measuring devices are used for detecting the excitation current and the regulator temperature, a device for calculating the calculated temperature as a function of at least the input variables of the excitation current and the regulator temperature, a device for calculating the change in the calculated temperature over time, a device for factorization of the calculated derivation of the calculated temperature, and a device for offsetting the additional offset with the prevailing limiting value for the excitation current.

With respect to the device for calculating the change in the calculated temperature over time, the sampling time must be selected in such a way that minor temperature fluctuations are not analyzed but any major temperature fluctuations are promptly reacted to. Sampling times between 5 s and 500 s may therefore be used. The sampling time may also be selected dynamically in such a way that it changes as a function of the measured variables and calculated variables.

Through the aforementioned factorization of the calculated derivation, the compensation of the influence of neighboring generator components may be adapted to different generators and different generator components.

If, as described above, the calculated additional offset is offset with the prevailing limiting value for the excitation current, i.e., is taken into account when ascertaining the calculated temperature, then the excitation current is limited promptly, so that the stator temperature may no longer exceed the diode temperature and consequently does not cause any further heat input.

If the behavior described above occurs to a critical extent only during a cold start, then a compensation may be performed which is not effective over the entire operation but instead is effective only immediately after a startup operation.

Within the scope of this compensation, a constant value may be taken into account over a previously defined period of time, a value which drops from a maximum value to a minimum value within a predefined period of time may be taken into account, a value which rises from a minimum value to a maximum value within a predefined period of time may be taken into account, a value as a function of the initially present calculated temperature which rises from a minimum value to a maximum value at a predefined slope may be taken into account, or a value as a function of the initially present calculated temperature which drops from a maximum value to a minimum value at a predefined slope may be taken into account.

1-12. (canceled)

13. A method for protecting an automotive generator from overheating, the method comprising:
shifting a predefined limiting characteristic curve, which belongs to a base temperature and describes a maximally allowed excitation current, as a function of an ascertained calculated temperature;
ascertaining a static offset during ascertainment of the calculated temperature in a first task; and
ascertaining a dynamic offset in a second task;
wherein the static offset is ascertained as a function of the excitation current and the dynamic offset is ascertained as a derivation of the excitation current over time.

14. The method of claim 13, wherein the static offset is ascertained as a function of the excitation current and the rotational speed of the automotive generator.

15. The method of claim 13, wherein the derivation of the excitation current is weighted.

16. The method of claim 13, wherein the derivation of the excitation current is subjected to a delay.

17. The method of claim 13, wherein the calculated temperature is calculated from the regulator temperature, the static offset and the dynamic offset.

18. The method of claim 17, wherein the calculated temperature is calculated using the following equation: TV=TR−SO+DO, where TV is the calculated temperature, TR is the regulator temperature, SO is the static offset, and DO is the dynamic offset.

19. The method of claim 13, wherein the limiting characteristic curve related to the base temperature is ascertained as a function of the rotational speed and the temperature of the automotive generator.

20. The method of claim 13, wherein the limiting characteristic curve related to the base temperature is ascertained as a function of the rotational speed, the temperature and the output voltage of the automotive generator.

21. The method of claim 13, wherein the shift in the limiting characteristic curve which depends on the calculated temperature is performed by using an offset obtained by using the base temperature and the calculated temperature.

22. The method of claim 21, wherein the shift in the limiting characteristic curve is performed using the following equation: TBW=BBW−F3·(TB−TV), where TBW is a temperature-dependent limiting value, BBW is a base limiting value, F is a factor, TB is the base temperature and TV is the calculated temperature.

23. The method of claim 13, wherein another offset is calculated for compensating for the influence of neighboring generator components and is taken into account when ascertaining the calculated temperature.

24. The method of claim 23, wherein the additional offset is taken into account during ascertainment of the calculated temperature only during a predefined time after the change in an operating mode.
